(19) United States
(12) Patent Application Publication
(10) Pub. No.: US 2018/0232588 A1
(43) Pub. Date: Aug. 16, 2018

(54) DRIVER STATE MONITORING DEVICE

(71) Applicant: Toyota Jidosha Kabushiki Kaisha, Toyota-shi Aichi-ken (JP)

(72) Inventor: Takeshi Matsumura, Numazu-shi Shizuoka-ken (JP)

(21) Appl. No.: 15/892,879

(22) Filed: Feb. 9, 2018

(30) Foreign Application Priority Data
Feb. 10, 2017 (JP) 2017-023299

(51) Int. Cl. G06K 9/00; B60Q 9/00; B62D 15/02; G08B 21/06

(52) U.S. Cl. CPC G06K 9/00845; B60Q 9/00; B60Y 2302/03; G08B 21/06; G06K 9/00302; B62D 15/02

(57) ABSTRACT

The driver state monitoring device monitoring the state or the driver is provided with a driver monitor camera capturing an image or the driver, an abnormality diagnosis part diagnosing a state of the driver or the driver state monitoring device based on an image sent from the driver monitor camera, and a warning part warning the driver of an abnormality when it is judged by the abnormality diagnosis part that an abnormality has occurred in the driver or the driver detection device. The abnormality diagnosis part is configured to judge that an abnormality has occurred in the driver or the driver state monitoring device, when an amount of change in a predetermined time of at least part of the image sent from the driver monitor camera is equal to or less than a predetermined amount of change.

### CROSS-REFERENCE TO RELATED APPLICATIONS

This application claims priority to Japanese Patent Application No.2017-023299 filed Feb. 10, 2017, which is incorporated herein by reference in its entirety including the specification, drawings, and abstract.

### TECHNICAL FIELD

The present disclosure relates to a driver state monitoring device.

### BACKGROUND ART

WO 2015/198542A discloses a driver state monitoring device detecting a state of a driver based on an image captured by a driver monitor camera, and judging if the driver is in a state unable to drive, based on the detected state of the driver. In particular, in WO 2015/198542A, as the state of the driver, whether a position of a head of the driver is not outside a predetermined range, whether a posture of the driver has not become off from usual, whether an orientation of the face of the driver has not become off from usual, whether the head of the driver is not abnormally shaking, and whether the driver is not in a state with his eyes rolled back, are detected.

Japanese Patent Publication No. 2008-097445A (JP2008-197445A) discloses a vehicular warning device comprising a distracted driving time counting device counting the time duration of a distracted driving state or the driver, a doze-off time counting of device counting the time duration of the state of the driver dozing off at the wheel, and a warning output device issuing a warning to the driver when the counted distracted driving time duration is a first predetermined time duration or more or when the counted time duration dozing off at the wheel is a second predetermined time duration or more.

### TECHNICAL PROBLEM

In the devices described in WO 2015/198542A and JP2008-197445A, when the image of the face of the driver sent from the driver monitor camera does not change, in particular, when the position of the head of the driver, the orientation of the face, or state of the eyes remains in a suitable state without changing, it is judged that there is no abnormality in the driving state or the driver.

Therefore, for example, if the driver monitor camera malfunctions and the image of the face of the driver sent from the driver monitor camera no longer changes, it is no longer possible to appropriately diagnose the driving state of the driver. Further, in the event, like in WO 2015/198542A, diagnosing abnormality of a driver by whether the driver is in a state with his eyes rolled hack or like in JP2008-197445A diagnosing that the driver has dosed off at the wheel based on the state of eyes closing, etc., if the driver doses off while his eyes remain open, it is no longer possible to appropriately diagnose the driving state of the driver. In addition, if the driver is wearing a mask covering the eyes, it is no longer possible to appropriately judge the state of the eyes of the driver, and as a result it is no longer possible to appropriately diagnose the driving state of the driver.

The present disclosure was made in consideration of the above problem, and has as its object the provision of a driver state monitoring device that is able to more appropriately detect a driving state of a driver.

### SOLUTION TO PROBLEM

The present disclosure was made so as to solve the above problem.

(1.) A driver state monitoring device monitoring a state of a driver, comprising: an capturing part for capturing an image of the driver; an abnormality diagnosis part for diagnosing a state of the driver or the driver state monitoring device, based on an image transmitted from the capturing part; and a warning part for warning the driver of an abnormality when it is judged by the abnormality diagnosis part that an abnormality has occurred in the driver or the driver state monitoring device, therein the abnormality diagnosis part is configured to judge that an abnormality has occurred in the driver or the driver state monitoring device, when an amount of change, in a given time duration, of at least part of the image sent from the capturing part is equal to or less than a predetermined amount of change.

2) The driver state monitoring device according to (1), wherein the abnormality diagnosis part judges that an abnormality has occurred in the driver state monitoring device, when an amount of change, in the given time duration, of the image sent from the capturing part is zero.

(3) The driver state monitoring device according to (2), wherein the warning part issues the driver a warning to the effect of an abnormality occurring in the system when it is judged by the abnormality diagnosis part that an abnormality has occurred in the driver state monitoring device.

(4)The driver state monitoring device according to any one of (1) to (3), wherein the abnormality diagnosis part judges that an abnormality has occurred at the driver when the amount of change, in the given time duration, of an image showing at least some of the parts of the face of the driver in the image sent from the capturing part is larger than zero and equal to or less than the predetermined amount of change.

(5) The driver state monitoring device according to (4), wherein the warning part issues a warning to the driver to the effect that an abnormality has occurred in the driver when it is judged by the abnormality diagnosis part that an abnormality has occurred in the driver.

(6) The driver state monitoring device according to (4) or (5), wherein the device further comprises an operation detection sensor for detecting operation of a steering wheel by the driver, and the abnormality diagnosis part judges that no abnormality has occurred in the driver when operation of the steering wheel is detected by the operation detection sensor in the given time duration, even when the amount of change, in the given time duration, of an image showing at least some of the parts of the face of the driver in the image captured by the capturing part is larger than zero and equal to or less than a predetermined amount of change.

### ADVANTAGEOUS EFFECTS

According to the present disclosure, there is provided a driver state monitoring device that is able to more appropriately detect a driving state of a driver.

### BRIEF DESCRIPTION OF DRAWINGS

FIG. 1 is a block diagram showing the constitution of a driver state monitoring device according to one embodiment of the present disclosure.

FIG. 2 is a view schematically showing the inside of a vehicle mounting a driver state monitoring device.

FIG. 3 is a flow chart showing a control routine for abnormality diagnosis control in a first embodiment.

FIG. 4 is a flow chart showing a control routine for abnormality diagnosis control in a second embodiment.

### DESCRIPTION OF EMBODIMENTS

Below, referring to the drawings, embodiments of the present disclosure will be explained in detail. Note that, in the following explanation, similar components are assigned the same reference numerals.

### First Embodiment

### Summary of Device

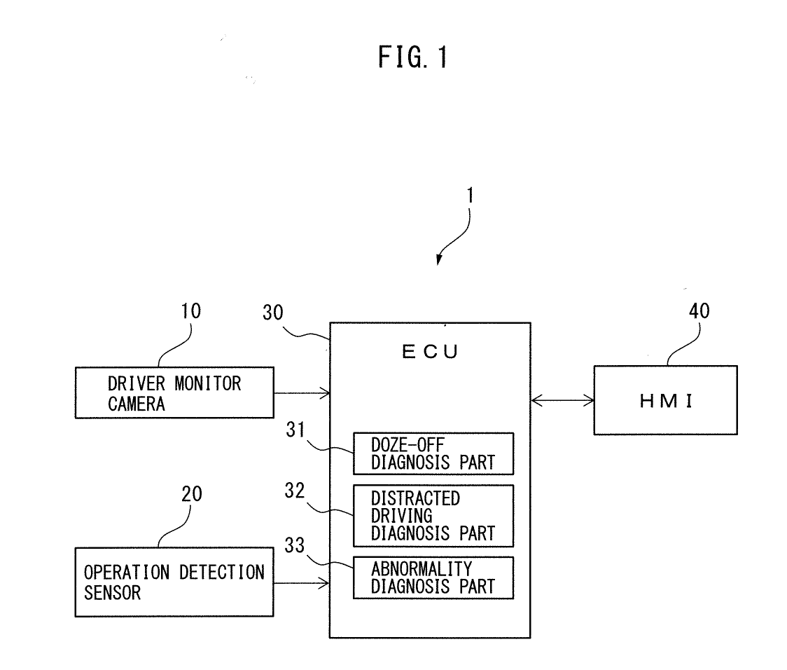

FIG. 1 is a block diagram showing the constitution of a driver state monitoring device 1 according to one embodiment of the present disclosure. The driver state monitoring device 1 is mounted in the vehicle and monitors the state of the driver of the vehicle. The driver state monitoring device 1 comprises a driver monitor camera 10, operation detection sensor 20, electronic control unit (ECU) 30, and human machine interface (HMI) 40.

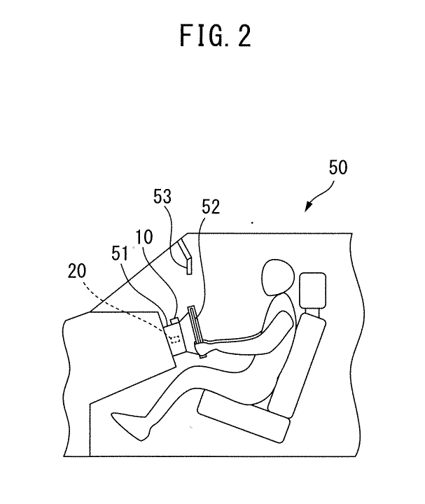

FIG. 2 is a view schematically showing the inside of a vehicle 50 mounting the driver state monitoring device 1. As shown in FIG. 2, the vehicle 50 comprises a sneering wheel 52 attached through a steering column 51, and an inner rearview mirror 53 arranged above the driver at the front. In the present embodiment, the driver monitor camera 10 is provided at the tog part of the steering column 51. It is arranged facing the driver so that the driver, specifically, the face of the driver and part of the upper torso, can be captured.

Note that, the driver monitor camera 10 does not necessarily have to be provided at the top part of the steering column 51. It may also be provided at another position so long as able to capture an image of the driver of the vehicle 50. For example, the driver monitor camera 10 ay also be provided at the steering wheel 52, inner rearview mirror 53, instrument panel, instrument hood, etc., of the vehicle 50.

The driver monitor camera 10 comprises a carrier a and lighting equipment. For example, the camera is a CMOS (complementary metal oxide semiconductor) camera or CCD (charge coupled device) camera, while the lighting equipment is an LED (light emitting diode). In some embodiments, the lighting equipment is a near infrared LED so as to enable the face of the driver to be captured without giving the driver an uncomfortable feeling even at the nighttime or otherwise when the brightness is low. In some embodiments, the camera can also detect near infrared rays. For example, the lighting equipment may be comprised of two near infrared LEDs arranged at the two sides of the camera. Further, the camera may also be provided with a filter such as a visible light cut filter.

The driver monitor camera 10 is connected by a cable or wirelessly with the ECU 30. Therefore, the image captured by the driver monitor camera 10 is transmitted as image data to the ECU 30.

The operation detection sensor 20 is a sensor detecting a steering operation by the driver. In the present embodiment, the operation detection sensor 20 is a torque sensor arranged in the steering column 51 and detecting a steering torque applied from the driver to the steering wheel. By detecting the steering torque applied by the driver, it is possible to detect if the driver is operating the steering wheel. The operation detection sensor 20 is also connected by a cable or wirelessly to the ECU 30. Therefore, the output of the operation detection sensor 20 is input to the ECO 30.

The ECU 30 is a microcomputer provided with components connected with each other by a bidirectional bus, such as a central processing unit (CPU), read only memory (ROM), random access memory (RAM), input port, and output port. In the present embodiment, a single ECU 30 is provided, but a plurality of ECUs connected with each other through a bus based on the CAN, etc., may also be provided for the different functions.

In the present embodiment, the ECU 30 is provided with a doze-off diagnosis part 31 diagnosing if the driver has dozed off at the wheel, a distracted driving diagnosis part 32 diagnosing if the driver is driving while distracted, and an abnormality diagnosis part 33 diagnosing any abnormality in the driver and driver state monitoring device 1.

The doze-off diagnosis part 31 processes the image input from the driver monitor camera 10 to calculate the amount of opening of the eyelids of the driver, and detects if the eyes of the driver are closed based on the calculated amount of opening of the eyelids. Specifically, in the present embodiment, the facial image captured by the driver monitor camera 10 is first corrected for orientation of the face or size of the face by affine transformation, etc., and next, the parts of the face (mouth, nose, and eyes) are identified by matching of the parts. Then, the maximum distance between the top and bottom lids, i.e., the amount of opening of the eyelids, is calculated, based on the boundary line of the parts of the eyes. When the thus calculated amount of opening of the eyelids is a predetermined reference value or less, it is judged that the eyelids are currently closed. This reference value may be a predetermined constant value, or may be a value obtained by detecting in advance the amount of opening of the eyelids when in the open state of the eyes for each driver and optimizing it based on this amount of opening. Note that, as the means for processing the image input from the driver monitor camera 10 to detect if the eyes of the driver are closed, the above-mentioned means need not necessarily be used, and any suitable means can be used.

In addition, the dose-off diagnosis part 31 calculates a time duration. Where it is detected by the above image processing that the eyes are closed (closed eye state). When the calculated time duration of the closed eye state is a predetermined doze-off judgment time duration or more, the doze-off diagnosis part 31 judges that the driver has dozed off at the wheel. Note that, the doze-off judgment time duration may be a time duration changed in accordance with the driving state of the vehicle 50, etc. For example, the doze-off judgment time duration may be set longer when the vehicle 50 has stopped, compared to when it is running.

The distracted driving diagnosis part 32 processes the image input from the driver monitor camera 10 to calculate the orientation of the face of the driver, and detects if the face of the driver is oriented toward the front based on the calculated orientation of the face. Specifically, the degrees of match of the positions or orientations of the different parts of the face identified by the matching processing as explained above and the positions or orientations of the same parts at different postures stored in advance (for example, posture when facing the front, etc.) are compared so as to calculate the current orientation of the face of the driver. When the thus calculated orientation of the face is deviated from the front by a predetermined reference amount or more, it is judged that the face of the driver is not oriented, toward the front. Note that, the operation for processing the image input from the driver monitor camera 10 to detect if the face of the driver is oriented toward the front, does not necessarily have to be performed by the above-mentioned means. Any suitable means can be used.

In addition, if it is detected by the above-mentioned image processing that the face of the driver is not oriented toward the front (distracted driving state), the distracted driving diagnosis part 32 calculates the time duration thereof. If the calculated time duration of the distracted driving state is a predetermined distracted driving judgment time duration or more, the distracted driving diagnosis part 32 judges that the driver is driving while distracted. Note that, the distracted driving judgment time duration may also be a time duration changing in accordance with the driving state of the vehicle 50, etc. For example, the distracted driving judgment time duration may be set longer when the speed of the vehicle 50 is slow, compared to when it is fast.

The abnormality diagnosis part 33 is configured so as to judge that an abnormality has occurred in the driver or driver state monitoring device 1, when the amount of change in a predetermined time duration of at least part of the image sent from the driver monitor camera 10 is a predetermined amount of change or less. Details of the abnormality diagnosis part 33 will be explained later.

The HMI 40 is an interface for input and output of information between the driver or a passenger and the driver state monitoring device 1. The HMI 40 comprises an information device for providing cue driver with various types of information, specifically, a display for displaying test information or image information, or a speaker for generating a sound. In addition, the HMI 40 comprises a microphone for picking up the voice of the driver and a touch panel or operating buttons or other input device for the driver to input information, etc.

The HMI 40 is connected to the ECO 30 by cable or wirelessly. Therefore, the information input by the driver, etc., is sent from the HMI 40 to the ECO 30. Further, information to be provided to the driver by the information device of the HMI 40 is sent from the ECU 30 to the HMI 40. For example, when it is judged by the doze-off diagnosis part 31 that the driver has dozed off at the wheel, a doze-off warning command is sent from the doze-off diagnosis part 31 to the HMI 40. If a doze-off warning command is sent this way, the HMI 40, for example, mates the speaker generate a warning sound and makes the display show a warning to the effect of paying attention against dozing off at the wheel. Further, when it is judged by the distracted driving diagnosis part 32 that the driver is driving while distracted, a distracted driving warning command is sent from the distracted driving diagnosis part 32 to the HMI 40. If a distracted driving warning command is sent this way, the HMI 40, for example, makes the speaker generate a warning sound and makes the display show a warning to the effect of paying attention against driving while distracted. In this way, the HMI 40 functions as a warning part warning the driver of an abnormality when an abnormality occurs in the driver (or when, as explained later, an abnormality occurs in the driver state monitoring device 1).

Note that, in the present embodiment, the ECU 30 comprises the doze-off diagnosis part 31 and distracted driving diagnosis part 32 as diagnosis parts judging the driving state of the driver. However, the ECU 30 may also be configured so as to judge a driving state of the driver other than dozing off at the wheel or driving while distracted. For example, it is also possible to judge that an abnormality has occurred at the driver when detecting the state of the eyes of the driver and the eyes of the driver are rolled back, judge that an abnormality has occurred at the driver when detecting movement of the driver and the driver is convulsing, or judge that an abnormality has occurred at the driver when detecting the posture of the driver and the driver is sitting slumped over.

### Problems

In this regard, as explained above, at the doze-off diagnosis part 31, when the eyes of the driver are maintained in the opened state in the image input from the driver monitor camera 10, it is judged that the driver has not dozed off at the wheel. Therefore, in this case, it is judged that there is no abnormality in the driving state of the driver. Further, in the distracted driving diagnosis part 32, when the state where the face of the driver is oriented toward the front is maintained in the image input from the driver monitor camera 10, it is judged that the driver is not driving while distracted. Therefore, in this case as well, it is judged that there is no abnormality in the driving state of the driver. Even when configured so as to make another judgment as explained above, if the state where the eyes of the driver are not rolled, back, the state where the driver is not convulsing, or the state where his posture is not slanted, etc., is maintained, it is judged that there is no abnormality in the driving state of the driver.

On the other hand, it the driver monitor camera 10 malfunctions, depending on the state of the malfunction, sometimes the image from the driver monitor camera 10 will no longer change along with time, but a certain past image will continue to be output. If the driver monitor camera 10 has malfunctioned, the image sent from the driver monitor camera 10 to the diagnosis parts 31 and 32 will no longer change. In this case, even if the driver doses off at the wheel or is driving while distracted, etc., the image from the driver monitor camera 10 does not change, and therefore it is not possible to judge if the driver has dosed off at the wheel or judge if he is driving while distracted.

Further, for example, when the driver is wearing a mask that covers his eyes, depending on the type of the mask, it will be judged that the eyes of the driver are open. For this reason, in this case, it is not possible to appropriately judge if the driver has dosed off at the wheel.

In addition, when the driver dozes off while his eyes remain open, or the driver is not focusing on the road in front of the vehicle 50 due to thinking about something despite his eyes being open, it is judged that the eyes of the driver are open and the face of the driver is oriented toward the front. For this reason, in this case, it is not detected that the driver is in an abnormal driving state such as dosing off at the wheel or driving while distracted.

If the driver monitor camera 10 or other part of the driver state monitoring device 1 malfunctions or the driver is wearing a mask covering his eyes, it is impossible to obtain the driving state of the driver and therefore it is impossible to appropriately diagnose the driving state of the driver. Further, if the driver dozes off while his eyes remain open, if judging the abnormality of the driving state of the driver based on simply if he closes his eyes, it is impossible to appropriately diagnose the abnormality of the driving state of the driver.

### Abnormality Diagnosis in Present Embodiments

To deal with this problem, in the present embodiment, the ECU 30 comprises an abnormality diagnosis part 33 mainly performing the following two operations. In other words, the abnormality diagnosis part 33 calculates the amount of change in a predetermined time duration of the image sent from the driver monitor camera 10. Further when the thus calculated amount of change is a predetermined reference value or less, it is judged that an abnormality has occurred in the driver or driver state monitoring device 1.

First, the method of calculation of the amount of change in the image sent from the driver monitor camera 10 will be explained. Various methods may be considered as the means for finding the extent of change in two or more images captured at different timings. Any method may be used, so long as it is possible to appropriately find the changes in these images.

As one example, in the present embodiment, the amount of change of an image is calculated based on the luminance of the pixels. I.e., the abnormality diagnosis part 33 compares the differences in luminance of the pixels in two or more images captured at different timings. Then, when comparing two or more images, the number of pixels with a large change in luminance where the difference in luminance is a predetermined value or more, is calculated. The ratio of the number of pixels with a large change in luminance calculated this way with respect to the total number of pixels is calculated as the amount of change of the image.

Then, if the amount of change of the image calculated this way is a predetermined reference value or less, it is judged that an abnormality has occurred in the driver or driver state monitoring device 1. As explained above, when using the ratio of the number of pixels with a large change in luminance with respect to the total number of pixels, as the amount of change of the image, it is judged that an abnormality has occurred in the driver or driver state monitoring device 1 when this ratio is a predetermined reference value (for example, 5%) or less.

In this regard, the amount of change of the image calculated as explained above, changes in accordance with the type of abnormality which occurs. For example, if the driver monitor camera 10 malfunctions and the same image continues to be output from the driver monitor camera 10, the image input to the abnormality diagnosis part 33 will not change, and therefore the calculated amount of change of the image will be zero.

On the other hand, even if the driver is wearing a mask covering his eyes, the driver moves in accordance with vibration of the vehicle, etc., and therefore the image output from the driver monitor camera 10 will change to some extent. Similarly, even when driver has dosed off with his eyes open or when the driver is not focused on the road in front of the vehicle 50, the driver moves in accordance with vibration of the vehicle, etc., and therefore the image output from the driver monitor camera 10 will also change to some extent. Therefore, in these cases, the calculated amount of change of the image will become larger than zero.

Therefore, in the present embodiment, the abnormality diagnosis part 33 judges that an abnormality has occurred in the driver state monitoring device 1, when the amount of change of the image calculated as explained above zero. In this case, a system abnormality warning command to the effect that an abnormality has occurred in the driver state monitoring device 1, i.e., the system, is sent from the abnormality diagnosis part 33 to the HMI 40. At the HMI 40, if a system abnormality warning command is sent, a warning is issued to the driver to the effect that an abnormality has occurred in the system. Specifically, the HMI 40, for example, makes the speaker generate a warning sound and makes the display show a warning to the effect that an abnormality has occurred in the system.

On the other hand, the abnormality diagnosis part 33 judges that an abnormality has occurred in the driver, when the amount of change of the image calculated in the above way is larger than zero and a predetermined reference value or less. In this case, a driver abnormality warning command to the effect that an abnormality has occurred in the driver is sent from the abnormality diagnosis part 33 to the HMI 40. At the HMI 40, if a driver abnormality warning command is sent, a warning is issued to the driver to the effect that an abnormality has occurred in the driver. Specifically, the HMI 40 makes the speaker issue a warning prompting the driver to exercise caution and makes the display system prompt caution.

Note that, the predetermined time duration for calculating the above-mentioned amount of change, may also be a predetermined certain time duration or a value changing in accordance with the situation of the vehicle, etc. If making it change in accordance with the situation of the vehicle, for example, when the vehicle is stopped, the predetermined time duration is set to be longer.

Further, in the above-mentioned embodiment, the amount of change of the image is calculated by comparing the images as a whole captured by the driver monitor camera 10, and abnormality of the driver or driver state monitoring device 1 is diagnosed based on the amount of change. However, the amount of change of the image may also not be calculated for the image as a whole captured by the driver monitor camera 10, but be calculated for part of the image captured by the driver monitor camera 10. In this case, for example, the amount of change is calculated for only the facial image in the image captured by the driver monitor camera 10 or for an image shoving one of the parts of the face.

Therefore, the abnormality diagnosis part 33 can be said to calculate the amount of change, in a predetermined time duration, of at least part of the image sent from the driver monitor camera 10. Further, the abnormality diagnosis part 33 can be said to judge that an abnormality has occurred in the driver, when the amount of change, in a predetermined time duration, of an image showing at least one of the parts of the face of the driver in the image sent from the driver monitor camera 10 is larger than zero and a predetermined amount of change or less.

Further, as explained above, when the driver monitor camera 10 has malfunctioned, the image does not change much at all. For this reason, the luminance of the pixels of the image sent from the driver monitor camera 10 also does not change at all. Therefore, in judging abnormality of the system, it is possible to use, as the amount of change of the image, the total of the changes of luminance of all pixels rather than using the ratio of the number of pixels with a large change in luminance with respect to the total number of pixels.

### Flow Chart

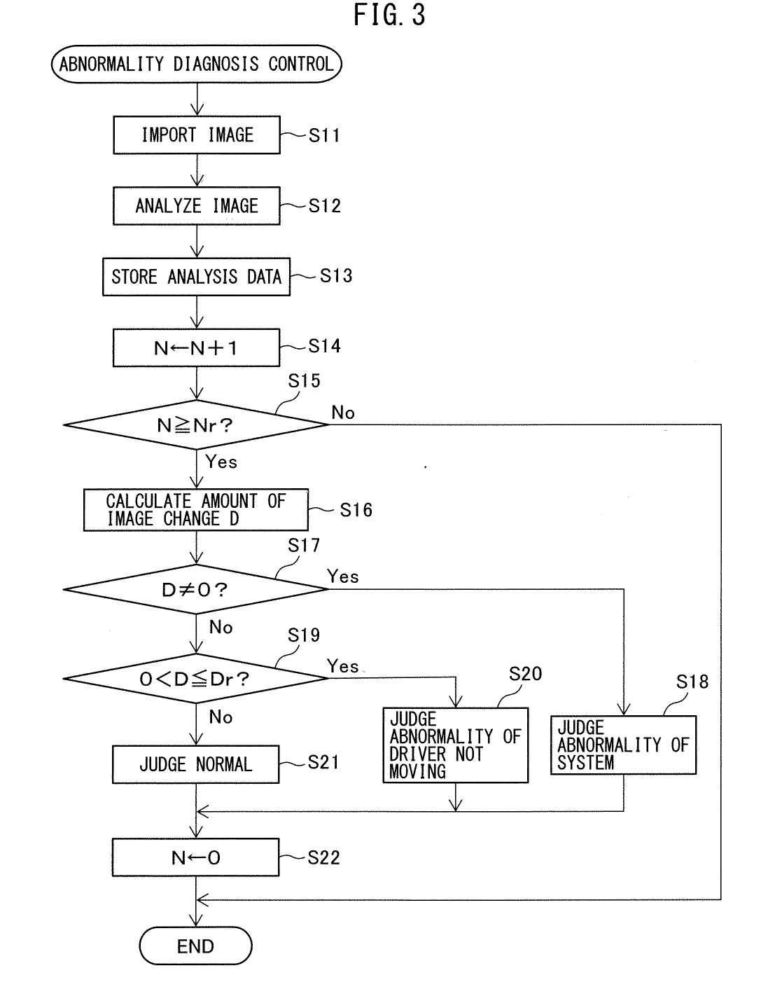

Next, referring to FIG. 3, abnormality diagnosis control for diagnosing abnormality of the driver or driver state monitoring device 1 will be explained. FIG. 3 is a flow chart showing a control routine for abnormality diagnosis control. The Illustrated control routine is executed at certain time intervals.

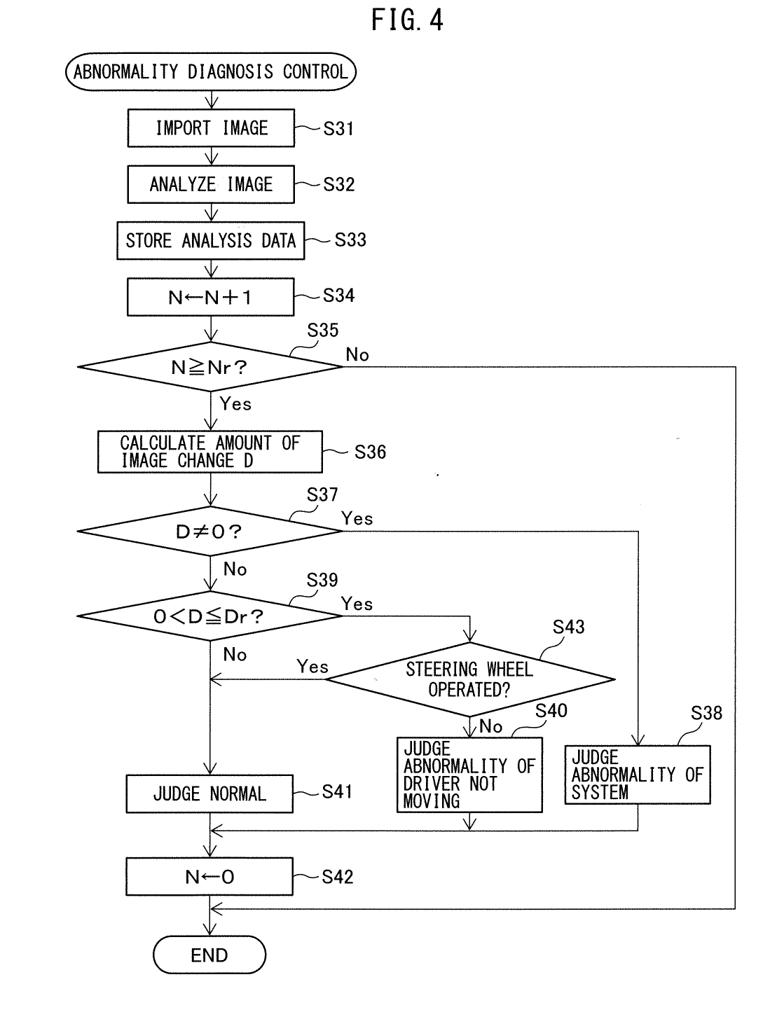

As shown in FIG. 4, first, at step S11, the image captured by the driver monitor camera 10 is imported from the driver monitor camera 10 to the abnormality diagnosis part 33. Next, at step S12, the image imported at step S11 is analyzed. Specifically, for example, the luminance at the pixels of the image imported at step S11 is calculated. Next, at step S13, the analysis data of the image analysis performed at step S12 is stored. Specifically, for example, the data showing the luminance at the pixels is stored.

Next, at step S14, the time counter N is incremented by 1. The time counter N is incremented by 1 every time the control routine is performed once, and functions as a counter showing the elapsed time since she control routine is performed at certain time intervals.

Next, at step S15, it is judged if the value of the time counter N calculated at step S14 has become equal to or more than a reference number Nr corresponding to the predetermined time in calculating the above-mentioned amount of change. The time counter N being less than the reference number Nr means that the predetermined time has still not elapsed from the start of the operation for importing the image for the current abnormality diagnosis. On the other hand, the time counter N being equal to or more than the reference number Nr means that the predetermined time or more has elapsed from the start of the operation for importing the image for the current abnormality diagnosis. When, at step S15, it is judged that the time counter N is less than the reference number Nr, the control routine is ended. On the other hand, when, at step S15, it is judged that the time counter N is equal to or more than the reference number Nr, the routine proceeds to step S16.

At step S16, the amount of image change D is calculated based on the analysis data stored at step S13. Specifically, the number of pixels having a difference of the luminance during a predetermined time duration (difference of maximum value and minimum value) equal to or more than a reference difference is calculated. Next, the ratio of the number of pixels with a change of luminance equal to or more than a reference difference with respect to the total number of pixels of the image used for calculating the amount of change (below, also referred to as the “ratio of changed pixels”) is calculated as the amount of image change D.

Next, at step S17, it is judged if the amount of image change D calculated at step S16 is zero. When at step S17 it is judged that the amount of image change D is zero the routine proceeds to step S18. At step S18, it is judged at the abnormality diagnosis part 33 that an abnormality has occurred in the system. As a result, a system abnormality warning command is sent from the abnormality diagnosis part 33 to the HMI 40. Next, the routine proceeds no step S23 where the time counter N is reset. On the other hand, when, at step S17, it is judged that the amount of image change D is not zero, the routine proceeds to seep S19.

At step S19, it is judged if the amount of image change D calculated at step S16 is larger than zero and equal to or less than a predetermined reference value Dr. When, at step S19, it is judged that the amount of image change D is larger than zero and equal to or less than the reference value Dr, the routine proceeds to step S20. At step S20, it is judged at the abnormality diagnosis part 33 that an abnormality has occurred in the driver. As a result, a driver abnormality warning command is sent from the abnormality diagnosis part 33 to the HMI 40. Next, the routine proceeds to step S23 where the time counter N is reset. On the other hand, when, at step S19, it is judged that the amount of image change D is larger than the reference value Dr, the routine proceeds to step S21.

At step S21, it is judged at the abnormality diagnosis part 33 that no abnormality has occurred in the system and driver. I.e., in the abnormality diagnosis part 33, it is judged that everything is normal. In this case, no warning command is particularly sent to the HMI 40. Then, the routine proceeds to step S23 where the time counter N is reset.

### Second Embodiment

Next, referring to FIG. 4, the driver state monitoring device 1 according to a second embodiment will be explained. The constitution and control of the driver state monitoring device 1 according to the second embodiment are basically similar to the constitution and control of the driver state monitoring device 1 according to the first embodiment. Therefore, below, the parts different from the constitution and control of the driver state monitoring device 1 according to the first embodiment will primarily be explained.

In this regard, as explained above, when the amount of change in the image captured by the driver monitor camera 10 is small, it is judged that an abnormality has occurred in the driver. However, for example, when driving along a long straight road or when driving along a curve with a small curvature, there is little change in the face of the driver, etc., even if the driver has not dozed off with his eyes remaining open or even if the driver is not thinking about something, etc., and thus is focusing on the road in front of the vehicle 50. Therefore, depending on the driving environment, etc., even if the driver has not dozed off with his eyes open or even if the driver is focusing on the road in front, the amount of change in the image captured by the driver monitor camera 10 is sometimes small.

On the other hand, when the driver has not dozed off with his eyes open or the driver is focusing on the road in front and thus the driver is driving the vehicle in a normal state, the driver will always operate the steering wheel 52 while driving the vehicle 50.

Therefore, in the present embodiment, the abnormality diagnosis part 33 judges that no abnormality has occurred in the driver, when the operation detection sensor 20 detects that the driver has performed a steering operation even if the amount of change of an image calculated in the above way is larger than zero and equal to or less than the predetermined reference value. As a result, the HMI 40 does not issue a warning to the driver. Due to this, the abnormality diagnosis part 33 is kept from making a mistaken judgment that an abnormality has occurred in the driver despite the driver operating the vehicle in a normal state, and from issuing an unnecessary warning to the driver.

Note that, as explained above, if considering the fact that the amount of change of the image may be calculated for part of the image captured by the driver monitor camera 10, in the present embodiment, the abnormality diagnosis part 33 can be said to judge that no abnormality has occurred in the driver, when a steering operation has been detected by the operation detection sensor 20 during a predetermined time duration, even if the amount of change, in a predetermined time duration, of an image showing at least some of the parts of the face of the driver in the image captured by the driver monitor camera 10 is larger than zero and equal to or less than a predetermined amount of change.

FIG. 4 is a flow chart showing a control routine for abnormality diagnosis control. The illustrated control routine is executed at certain time intervals. Note that, steps S31 to S42 at FIG. 4 are similar to steps S11 to S22 at FIG. 3, respectively, and therefore explanations will be omitted.

When at step S39, it is judged that the amount of image change D is larger than zero and equal to or less than the reference value Dr, the routine proceeds to step S43. At step S43, it is judged if a steering wheel is operated during the time period until the value of the time counter N changes from 0 to the reference number Nr or more. Specifically, it is judged if the steering wheel is operated based on whether the steering torque detected by the torque sensor used as the operation detection sensor 30 has become a predetermined value or more during the above time period.

When at step S43 it is judged that the steering wheel was operated during the above time period, the routine proceeds to step S41. On the other hand, when, at step S43, it is judged that the steering wheel has not been operated, the routine proceeds to step S40.

1. A driver state monitoring device for monitoring a state of a driver, comprising:
a capturing part for capturing an image of the driver; an abnormality diagnosis part for diagnosing a state of the driver or the driver state monitoring device, based on an image transmitted from the capturing part; and a warning part for warning the driver of an abnormality when it is judged by the abnormality diagnosis part that an abnormality has occurred in the driver or the driver state monitoring device,
wherein the abnormality diagnosis part is configured to judge that an abnormality has occurred in the driver or the driver state monitoring device, when an amount of change, in a given time duration, of at least part of the image sent from the capturing part is equal to or less than a predetermined amount of change.

2. The driver state monitoring device according to claim 1, wherein the abnormality diagnosis part judges that an abnormality has occurred in the driver state monitoring device, when an amount of change, in the given time duration, of the image sent from the capturing part is zero.

3. The driver state monitoring device according to claim 2, wherein the warning part issues the driver a warning to the effect of an abnormality occurring in the system, when it is judged by the abnormality diagnosis part that an abnormality has occurred in the driver state monitoring device.

4. The driver state monitoring device according to claim 1, wherein the abnormality diagnosis part judges that an abnormality has occurred at the driver when the amount of change, in the given time duration, of an image showing at least some of the parts of the face of the driver in the image sent from the capturing part is larger than zero and equal to or less than the predetermined amount of change.

5. The driver state monitoring device according to claim 4, wherein the warning part issues a warning to the driver to the effect that an abnormality has occurred in the driver, when it is judged by the abnormality diagnosis part that an abnormality has occurred in the driver.

6. The driver state monitoring device according to claim 4, wherein
the device further comprises an operation detection sensor for detecting operation of a steering wheel, by the driver, and
the abnormality diagnosis part judges that no abnormality has occurred in the driver, when operation of the steering wheel is detected by the operation detection sensor in the given time duration, even when the amount of change, in the given time duration, of an image showing at least some of the parts of the face of the driver in the image captured by the capturing part is larger than zero and equal to or less than the predetermined amount of change.

7. The driver state monitoring device according to claim 5, wherein
the device further comprises an operation detection sensor for detecting operation of a steering wheel by the driver, and
the abnormality diagnosis part judges that no abnormality has occurred in the driver, when operation of the steering wheel is detected by the operation detection sensor in the given time duration, even when the amount of change, in the given time duration, of an image showing at least some of the parts of the face of the driver in the image captured by the capturing part is larger than zero and equal to or less than the predetermined amount of change.

8. The driver state monitoring device according to claim 2, wherein the abnormality diagnosis part judges that an abnormality has occurred at the driver when the amount of change, in the given time duration, of an image showing at least some of the parts of the face of the driver in the image sent from the capturing part is larger than zero and equal to or less than the predetermined amount of change.

9. The driver state monitoring device according to claim 3, wherein the abnormality diagnosis part judges that an abnormality has occurred at the driver when the amount of change, in the given time duration, of an image showing at least some of the parts of the face of the driver in the image sent from the capturing part is larger than zero and equal to or less than the predetermined amount of change.

10. The driver state monitoring device according to claim 8, wherein the warning part issues a warning to the driver to the effect that an abnormality has occurred in the driver, when it is judged by the abnormality diagnosis part that an abnormality has occurred in the driver.

11. The driver state monitoring device according to claim 9, wherein the warning part issues a warning to the driver to the effect that an abnormality has occurred in the driver, when it is judged by the abnormality diagnosis part that an abnormality has occurred in the driver.

12. The driver state monitoring device according to claim 8, wherein
the device further comprises an operation detection sensor tor detecting operation of a steering wheel by the driver, and
the abnormality diagnosis part judges that no abnormality has occurred in the driver, when operation of the steering wheel is detected by the operation detection sensor in the given time duration, even when the amount of change, in the given time duration, or an image showing at least some of the parts of the face of the driver in the image captured by the capturing part is larger than zero and equal to or less than the predetermined amount of change.

13. The driver state monitoring device according to claim 9, wherein
the device further comprises an operation detection sensor for detecting operation of a steering wheel by the driver, and
the abnormality diagnosis part judges that no abnormality has occurred in the driver, when operation of the steering wheel is detected by the operation detection sensor in the given time duration, even when the amount of change, in the given time duration, of an image showing at least some of the parts of the face of the driver in the image captured by the capturing part is larger than zero and equal to or less than the predetermined amount of change.

14. The driver state monitoring device according to claim 10, wherein
the device further comprises an operation detection sensor for detecting operation of a steering wheel by the driver, and
the abnormality diagnosis part judges that no abnormality has occurred in the driver, when operation of the steering wheel is detected by the operation detection sensor in the given time duration, even when the amount of change, in the given time duration, of an image showing at least some of the parts of the face of the driver in the image captured by the capturing part is larger than zero and equal to or less than the predetermined amount of change.

15. The driver state monitoring device according to claim 11, wherein
the device further comprises an operation detection sensor for detecting operation of a steering wheel by the driver, and
the abnormality diagnosis part judges that no abnormality has occurred in the driver, when operation of the steering wheel is detected by the operation detection sensor in the given time duration, even when the amount of change, in the given time duration, of an image showing at lease some of the parts of the face of the driver in the image captured by the capturing part is larger than zero and equal to or less than the predetermined amount of change.
